(19) United States
(12) Patent Application Publication
(10) Pub. No.: US 2020/0034350 A1
(43) Pub. Date: Jan. 30, 2020

(54) Data Table Control

(71) Applicant: Arm IP Limited, Cambridge (GB)

(72) Inventor: Brendan James Moran, Histon (GB)

(73) Assignee: Arm IP Limited, Cambridge (GB)

(21) Appl. No.: 16/521,815

(22) Filed: Jul. 25, 2019

(30) Foreign Application Priority Data
Jul. 26, 2018 (GB) 1812162.4

(51) Int. Cl. G06F 16/22; G06F 7/08

(52) U.S. Cl. CPC G06F 16/2282; G06F 7/08

(57) ABSTRACT

A technology is provided for sorting and accessing table data, comprising: receiving a request to retrieve data from a table having constant size keys and constant size data, the request specifying a key associated with data to be retrieved, the table having been sorted according to a sort order of transformed values derived by applying a consistent computational transform to each of the constant size keys; generating a first estimate of a table row for the specified key by transforming the key specified in the request into a transformed value using the consistent computational transform and applying a root-finding method to determine a table row; testing a table row key at the table row derived from the first estimate for a match with the specified key; and responsive to finding a matched table row in the testing, returning a data value from the matched table row for the specified key.

### BACKGROUND

The present technology relates to methods and apparatus for the control of data tables in electronic data processing devices.

In the computing art, tables of data, whether held in memory or stored using other storage means, are frequently used at all levels of the processing stack. Control of such tables of data comprises actions such as locating a table row, reading, writing, and deleting data, sorting the table, etc. Table manipulation operations, for example, are required at all levels of computing system activity, from low-level address translation tables at the machine level to high-level database table lookups. These table manipulation operations all have implementation costs in terms of, for example, actual time, processor use time, energy consumption, and storage footprint.

Many computational processes require the searching for and retrieval of data from a large table, such as a table of key-value pairs. This may be the case, for example, for an operating system level address translation table, a lookup table of function identifiers, a table of networked device identifiers, and the like.

There are several methods of locating the required row of such a table, including:
Linear search
Binary search
Interpolation search
Hybrid binary/linear search: binary for coarse matching and linear for precise matching
Index tables
Hash tables
Database access method search operations, such as those provided by SQLite

Each of these methods has costs and benefits. Broadly speaking, the linear, binary, interpolation and hybrid searches do not increase the table size, and thus the storage footprint, whereas the index-based tables, hash tables, and database access methods all do increase the table size. Each of the methods also has costs and benefits in terms of setup processing, runtime complexity and processing costs and energy consumption. For example, a linear search is extremely slow for long tables, while interpolation search is very sensitive to the distribution of the table, which means that some types of unevenly distributed data can change the complexity of the search process from 0(log(log(n)), which is the best-case complexity, to 0(n), which is the worst-case complexity.

### BRIEF DESCRIPTION OF THE DRAWINGS

FIG. 1 shows a block diagram of an arrangement of logic, firmware or software components by means of which the presently described technology may be implemented;

FIG. 2 shows an example of a plot of transform value to table row;

FIG. 3 shows one example of a method of data table preparation according to the presently described technology; and

FIG. 4 shows one example of a method of data table access according to the presently described technology.

### DETAILED DESCRIPTION

In a first approach to the many difficulties encountered in efficiently controlling data tables, the present technology provides a computer-implemented method for accessing table data, comprising: receiving a request to retrieve data from a table having constant size keys and constant size data, the request specifying a key associated with data to be retrieved, the table having been sorted according to a sort order of transformed values derived by applying a consistent computational transform to each of the constant size keys; generating a first estimate of a table row for the specified key by transforming the key specified in the request into a transformed value using the consistent computational transform and applying a root-finding method to determine a table row; testing a table row key at the table row derived from the first estimate for a match with the specified key; and responsive to finding a matched table row in the testing, returning a data value from the matched table row for the specified key.

The root-finding method may comprise a Newton-Raphson method. The transformed values may be discarded after the table has been sorted. The consistent computational transform may comprise a hash function. The hash function may comprise a well-distributed hash function, and the root-finding method may comprise a simplified Newton-Raphson method.

The present technology further provides a computer-implemented method for accessing table data, comprising: receiving a request to retrieve data from a derived table generated from a table having constant size keys and constant size data, the request specifying a key associated with data to be retrieved, the derived table having been sorted according to a sort order of transformed values derived by applying a consistent computational transform to each of the constant size keys, and replacing each key with its respective transformed value as a table row index value after the derived table has been sorted; generating a first estimate of a table row for the specified key by transforming the key specified in the request into a respective transformed value using the consistent computational transform and applying a root-finding method to determine a table row; testing a table row index value at the table row derived from the first estimate for a match with the respective transformed value of the specified key; and responsive to finding a matched table row in the testing, returning a data value from the matched table row for the specified key.

The root-finding method may comprise a Newton-Raphson method. The consistent computational transform may comprise a hash function. The hash function may comprise a well-distributed hash function, and the root-finding method may comprise a simplified Newton-Raphson method.

There is also provided a computer-implemented method for sorting a table, comprising: applying a consistent computational transform to constant size keys of a table to generate transformed values, the table comprising the constant size keys and associated constant size data; and sorting the keys and data of the table according to a sort order of transformed values.

In a hardware approach, there is provided electronic apparatus comprising logic components operable to implement the methods of the present technology.

The present technology further provides computer program code operable, when loaded into a computer and executed thereon, to cause said computer to operate logic circuitry to perform the method of the present technology.

The present technology further provides a computer-readable storage medium storing the computer program code of the present technology.

The present technology further provides a computer-readable storage medium storing a data structure comprising a table of constant size keys and constant size data, said table being sorted according to a sort order of transformed values derived by transforming each of said constant size keys using a consistent computational transform.

The present technology further provides a computer-readable storage medium storing a derived data structure generated from a table of constant size keys and constant size data, said table being sorted according to a sort order of transformed values derived by transforming each of said constant size keys using a consistent computational transform.

The table may be stored inside a bucket of storage locations of a hash table.

The table may replace a linked list of storage locations in said bucket.

The present technology further provides a computer-readable storage medium configured to store a data structure comprising a subset of entries from a table of constant size keys and constant size data, said table being sorted according to a sort order of transformed values derived by transforming each of said constant size keys using a consistent computational transform, said table being divided into local subsets of entries stored at different storage locations after said being sorted.

A plurality of said computer-readable storage media may be provided, each storing a different local subset of entries of the table.

A data processing system may be provided comprising the abovementioned local subsets and plural processor logic components, each said processor logic component adapted to access a local subset in one of said storage locations distributed across said plurality.

Implementations of the disclosed technology will now be described, by way of example only, with reference to the accompanying drawings, in which:

The present technology thus provides computer-implemented techniques and logic apparatus for efficiently sorting, locating and retrieving data from electronically-stored data tables. In various implementations, the locating and retrieving of the data is performed more quickly than can be achieved with several other methods, while the data storage footprint is maintained without significant increase in size.

Broadly, the present technique involves transformation of the key associated with table row data in the table using a consistent computational transform function. For this purpose, a consistent computational transform function is one that takes a fixed size key argument as input and deterministically yields a corresponding fixed size binary transform value as output. The table is then sorted according to a sort order of the transformed values. When a request to locate table row data by key is received, the specified key may be transformed to yield its transform value; its corresponding table row may then be located by applying a root finding method to determine by iterative approximations the table row key that maps to the specified key and to return the data for that row. This approach addresses the known problem that sets of keys to table data are not themselves well-distributed, and thus the computations to locate table entries by key are complex and make the use of additional indexing, hashing techniques and lengthy search techniques, such as binary search, necessary. Certain computational transformations, and particularly well-distributed transformations, are amenable to more efficient searching techniques, as shown in the following description of the present technology.

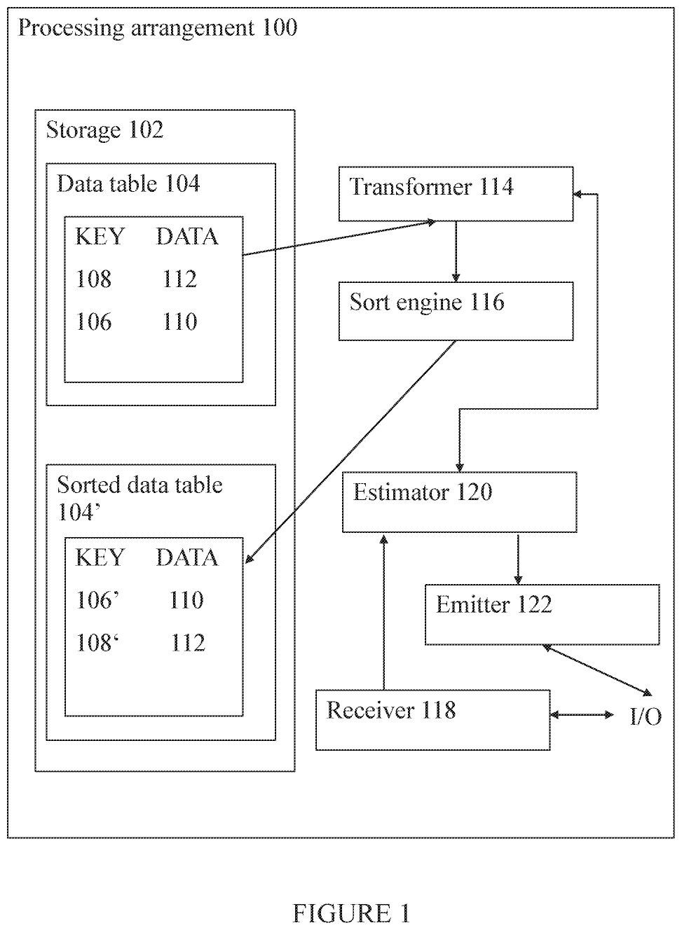

In FIG. 1, there is shown a block diagram of an exemplary processing arrangement 100 comprising logic components, firmware components or software components by means of which the presently described technology may be implemented.

In storage 102 is located a data table 104 having constant size keys 106, 108 . . . and constant size data 110, 112. Computational transformer 114 is operable to apply a consistent computational transform to each of the constant size keys 106, 108 . . . to derive respective transformed values 106′, 108′ . . . Sort engine 116 is operable to sort data table 104 according to the sort order of the transformed values 106′, 108′ . . . and to replace data table 104 with sorted table 104′ in storage 102. Sort engine 116 may be operable to retain in storage 102 the constant size keys 106, 108 . . . and discard the transformed values 106′, 108′ . . . , to retain in storage 102 the transformed values 106′, 108′ . . . and discard the constant size keys 106, 108 . . . , or to retain in storage 102 both the constant size keys 106, 108 . . . and the transformed values 106′, 108′ . . . .

Each of these cases has advantages and disadvantages. For example, in the case where the transformed values are discarded (a “null-index” table), no additional storage is required for the table, compared to conventional hash tables, indexed tables, and databases. For example, an SQLite database is 2.5 times the size of an equivalent null-index table.

In the case where the transformed values are retained and the key values are discarded, it becomes possible to make a table publicly visible without any indication of its structure—this makes the raw data essentially meaningless to unauthorised persons attempting to access and use the table without knowledge of the order imposed by the specific transform used. To share a table between several systems, the sorting by transform value can be replaced with, for example, hash-based message authentication code (HMAC) ordering so that an unauthorised person would have difficulty manipulating the table, and any attempt so to manipulate it would be highlighted as it would have a noticeably different access pattern from any authorized access.

If, the table having been sorted, it is determined that the key is to be discarded and replaced with its respective transformed value as a table row index value, comparator 122 is operable to test the table row index value, rather than the table row key, at the table row derived from the estimate for a match with the respective transformed value.

In the case where both key and transform values are retained, there is a greater level of flexibility for the application of different access methods, depending on the circumstances at the time of the request for data, but this flexibility is at the expense of an increase in the storage footprint of the table.

Arrangement 100 further comprises receiver 118 operable to receive a request to retrieve data from a data table 104. The request, if properly formed, specifies a key in the form of one of the constant size keys 106, 108 . . . associated with the data to be retrieved. Receiver 118 passes the received key to estimator 120 which is operable to perform an estimate of a table row for the specified key by calling computational transformer 114 to apply the same consistent computational transform to the specified key to derive a transformed value in the form of one of the transformed values 106′, 108′ . . . . Computational transformer 114 passes the derived transformed value to estimator 120, which is operable to apply a computational root-finding method to determine a table row having a key value approximating to the value of the specified key, as determined by comparator 122 operable to test the table row key at the table row in sorted table 104′ derived from the first estimate for a match with the specified key. If comparator 122 finds a match, it signals the event to data emitter 124, which is operable to return the data value from the matched table row to the requester.

In one variant, additional comparator 122 logic may be operable to test one or more preceding and succeeding table row keys for a match with the specified key, and additional data emitter 124 logic may be operable in response to finding a matched table row, to return a data value from the matched table row for the specified key.

In either the base case or the described variant, if comparator 122 does not find a match, additional comparator 122 control logic may be operable to cause comparator 122 to iteratively call estimator 120 to apply the root-finding method to produce converging approximations until a match is found. The root finding computation may be combined with a maximum and minimum bound check and comparator 122 may comprise additional logic such that if iterations of the root finding method combined with the maximum and minimum bound check produce a result falling outside a range between said maximum and minimum bound, comparator 122 may call estimator 120 to apply a bisection method to counter the divergence. Maximum and minimum bounds for the maximum and minimum bound check may be set, adjusted and stored during the iterative application of the root-finding method by estimator 120.

In this case, estimator 120 retains both the maximum lower bound (rowₘₐₓ) and the minimum upper bound (rowₘᵢₙ). On the first iteration,

rowₘᵢₙ=0, and rowₘₐₓ=N

If any estimate using the initial root finding method falls outside the range [rowₘᵢₙ, rowₘₐₓ], the bisection method may be used instead of a further iteration of the initial root finding method, in order to counter the divergence in the approximation.

On each iteration, the maximum lower bound and the minimum upper bound are updated according to:

rowₘᵢₙ={rowᵢ+T, if(ROW[rowᵢ+T]key<H(key))

rowₘᵢₙ, otherwise . . .

rowₘₐₓ={rowᵢ−T, if H(ROW[rowᵢ−T]key>H(key))

rowₘₐₓ, otherwise . . .

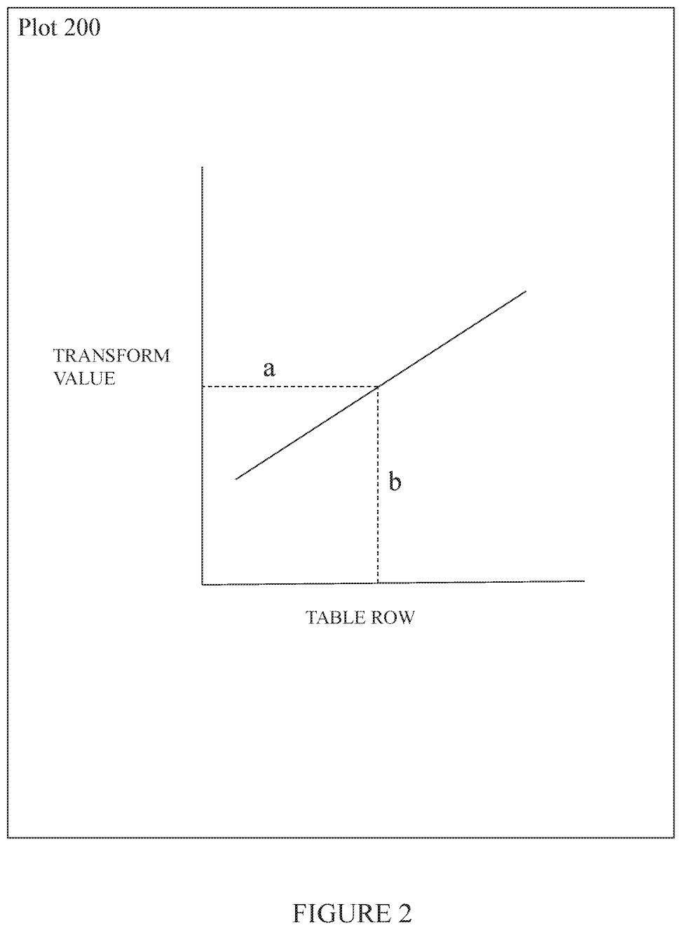

In one implementation, the estimator 120 is operable to apply the Newton-Raphson method of approximation. In this method, the instantaneous slope of the plot (y=f(x)) of transform value (y) to table row (x) is determined by differentiation, and the x-intercept of the tangent at the transform value is taken as the table row position at which comparator 122 is to test the key. In another implementation, when the transform function is well-distributed (that is, it gives a linear or near-linear plot of transform value to table row), the slope of the plot is near constant, and thus the differentiation step may be omitted from the Newton-Raphson approximations performed by estimator 120. (A well-distributed transform function may give an even distribution, or an uneven, sparse distribution, but providing that the chosen transform function gives a plot with at least near constant slope, the differentiation step may be omitted from the root-finding method). This may be regarded as a “simplified Newton-Raphson method”, and it has the advantage of reducing the computational processing required for each iteration of the method, and thus the time taken to locate the table row corresponding to the specified key. See FIG. 2 for a representation of an exemplary plot 200 of transform value to table row in such a well-distributed transform, with guide lines (dotted lines a, b) showing a root estimation according to the present technology.

The plot of key transform to row is approximately:

$$H ( key ) = \frac{row \cdot {2}^{n}}{N}$$

where:
( ) is the computational transform function;
key is the key;
row is the row number;
n is the number of bits in the transform function output; and
N is the number of rows in the table.

H( ) can be any consistent computational transform function. In one implementation, it may be a well-distributed hash function such as the well-known SHA256 and FNV1a-32 hash functions, for example.

In one efficient implementation, where the table size is not to be increased (thus creating a “null-index” table), where such a well-distributed transform function is to be used, and thus where a simplified Newton-Raphson method is applicable, an exemplary procedure according to the present technology may be outlined as follows:

1. Construct a sorted null-index table:
a. Take a table of constant-size keys and constant size values.
b. Transform each key.
c. Sort the table by the transform value of the keys, but do not include the transform values in the table.
   2. Locate data, specifying a key, in the sorted null-index table:
a. Perform an initial estimate:

$${row}_{0} = \frac{H ( key ) \cdot N}{{2}^{n}}$$

where:
   N is the number of records;
   ( ) is the transform function;
   key is the specified (target) key for the required data; and
   n is the number of bits in the transform function.
b. Optionally, read T rows on either side of the estimate as well as the estimate.
c. Check if the target key has been exactly located by step a or is in the range that has been read in step b:

H(ROW[rowᵢ−T]_{key})≤H(key)≤H(ROW[rowᵢ+T]_{key})
d. If so, return the table row data for key. Otherwise, calculate the next estimate:

$${row}_{i} = {row}_{i - 1} - \frac{( H ( key ) - H ( {ROW [ {row}_{i - 1} ]}_{key} ) ) \cdot N}{{2}^{n}}$$

Then, return to optional step b or step c.

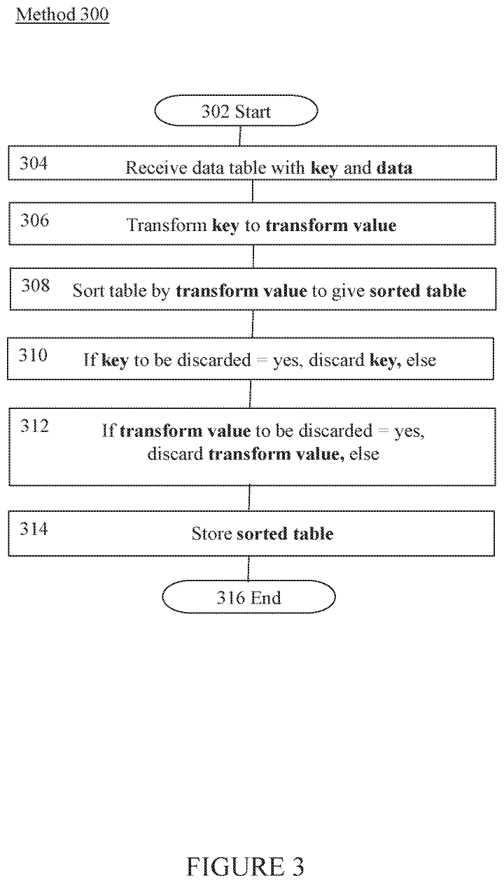

Turning now to FIG. 3, there is shown one example of a method 300 of data table preparation according to the presently described technology. The method commences at Start 302. At 304 a data table comprising keys and associated data is received for processing. At 306 each key of the data table is transformed according to the chosen consistent computational transform function to give its transform value. At 308, the table is sorted according to a sort order of transform values to give a sorted table. The sort may be in ascending or descending sort order, according to any local requirements. If the key is to be discarded, that is done at 310 after the sort at 308. If the transform value is to be discarded, that is done at 312 after the sort at 308. The sorted table is stored at 314, and the data table preparation process completes at End 316.

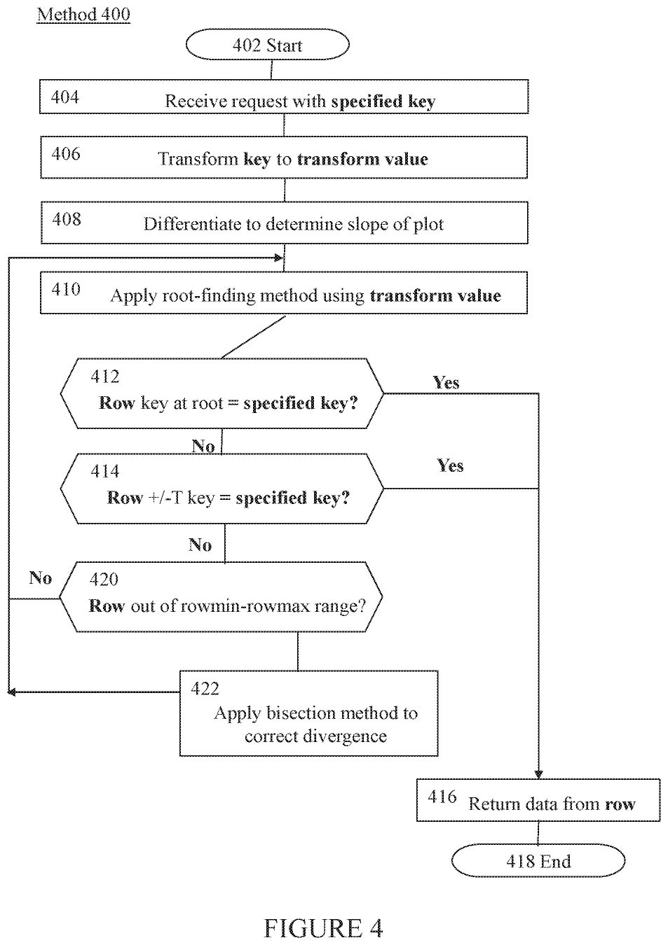

FIG. 4 shows one example of a method 400 of data table access according to the presently described technology. The subject data table to be accessed has been prepared as described in FIG. 3. Method 400 commences at Start 402, and at 404 a request is received to access data in the data table at a location defined by a specified key. At 406, the specified key is transformed according to the chosen consistent computational transform function to give its transform value, and an initial estimate as to a row is generated. At 408, if necessary for the selected root-finding method, the instantaneous slope of the plot of transform value to table row is determined by differentiation. As described above, the differentiation step may be omitted from the root-finding method in certain cases. At 410, the root finding method is applied to produce an estimated root using the transform value of the specified key. At 412, the key of the row at the estimated root is tested for a match with the specified key. If 412 returns a match, the process moves to 416, the data from the matched row is returned, and the process completes at End 418. If 412 does not return a match, an optional extension of the test scope may be provided at 414, where one or more preceding and succeeding rows (set as parameter T) may also be tested for a match. If 414 returns a match, the process moves to 416, the data from the matched row is returned, and the process completes at End 418. If 414 does not return a match, an optional extension of the method may be provided at 420 to test for divergence of the root finding method, using the rowₘᵢₙ and rowₘₐₓ values in the manner already described above. If 420 finds divergence, the bisection method is applied at 422 to counter the divergence. The root-finding process iterates until the correct row is found, when the process moves to 416, the data from the matched row is returned, and the process completes at End 418.

Because the table search algorithm is dependent only on the transform algorithm and the number of records, any sub-table can be constructed purely by preserving the ordering of its member elements when they are extracted from the primary table. In one example, a sub-table of sparsely selected values can be constructed by preserving the ordering. This technique can be used when selecting only some of the elements in a table for further processing. In effect, this provides a mechanism to return selected search results in an identical order to that of the original table. In an exemplary use-case for this, based on distribution of data over many mesh networks, the gateway of any given subnet may request a sub-table of the data to be delivered, consisting only of the devices it knows are in its mesh network.

The sub-table strategy can also be used to divide the table in a non-sparse manner, for example, to arrange for smaller blocks of contiguous memory or smaller files. The technology can use, for example, some of the high-order bits of the transform value as an identifying prefix to select the right bucket, file, or worker process, and then use the search algorithm detailed above to search for the key within that bucket, file, or worker process subset. Further, because insertions are made in a smaller table subset, they are much less processor-intensive, as the whole table does not need to be resorted to accommodate the new data.

In one implementation, a conventional hash table can be augmented by applying the present technology. Instead of storing a linked list for each bucket, the constant size keys and constant size data are stored as a flat array after the transform values have been used to sort the data. A search then proceeds with estimator 120, prior to performing an estimate of a table row for the specified key, determining from, for example, some of the high-order bits of the transform value that the table row is an element of a subset located in a bucket of a hash table, and limiting its performance of the estimating algorithm to that subset.

In another implementation, the table can be distributed across plural separate systems by using, for example, some of the high-order bits of the transform value to identify the owning system. Because the table has nearly even distribution, the table can easily be thus subdivided by this identifying prefix. The remainder of the transform value is then used for the search algorithm as described above, but with a smaller number of table rows and a smaller number of transform value bits. If, as described above, the transform values are well distributed, the processing load of conducting searches is balanced across the participating systems. In a data processing system comprising such local subsets, there may be provided plural processor logic components, each processor logic component being adapted to access a subset in one of the storage locations (typically one local to the processor logic component) distributed across the plurality of owning systems.

In a further implementation, the presently-disclosed technology may be applied in circumstances in which data elements in a table are of variable size. By applying the present technology to provide lookup capability to a first-level table containing data in the form of offset and size pairs which in turn provide access to a flat file containing a second table of variable-size data at identified offsets, the efficient lookup of table data provided by the present technique may be gained.

In an example of an implementation of the present technique, data in the form of a firmware update may need to be delivered to a plurality of recipients from a firmware update service. In order to maintain security, the firmware update service delivers the firmware in an encrypted form. In order to improve network performance, each of the recipients can be enabled to decrypt the firmware with the same content encryption key, however, it is necessary for each of the recipients to arrive at the same content encryption key without exposing the content encryption key to anyone else.

The content encryption key is therefore uniquely encrypted for each of the recipients, thus preventing the content encryption key being exposed to anyone else. Then, the encrypted content encryption key for each recipient is sorted in a table as previously described. This allows a distribution server to then implement the previously described algorithm and rapidly deliver the correct content encryption key to each recipient without knowing the content encryption key. The use of the above described content encryption key distribution method may be more efficient in the use of distribution server resources than using a normal database or a search in a text file. Thus the method may be used to reduce the consumption of resources compared to other techniques and allow for a larger scale distribution system to distribute firmware updates to large numbers of devices.

In another example of an implementation of the present technique for distributing an encrypted content encryption key, the distribution server does not implement the previously described algorithm. In this case, the distribution server may be a normal webserver, therefore not requiring specific infrastructure. Instead, each recipient performs the algorithm, for example using an iterative approximation technique as previously described. The recipient therefore performs a series of queries at specific offsets into a table itself to find its own content encryption key. Effectively, this means that a distribution server, and a recipient can implement the algorithm when working together.

In another example, the present technique can be implemented in a remote monitoring and control system, such as an Internet of Things (IoT) management system or service. In this example, the system uses preconfigured session keys, for example, Datagram Transport Layer Security (DTLS) session keys that are established during the end-node manufacturing process. All session information is stored in {device-id, session info} pairs in a table, as described above. The system may only retain end-node metadata for a short period of time after the end-node has last made a report. When an end-node connects and its metadata is not present in the system, the system locates the end-node's device identifier in the table, using the above described table search algorithm. When a device is forgotten by the system, its fixed size session information is updated in the table. This reduces the time to bring a forgotten device back on-board, it reduces the load on the system, and it reduces the storage space required for the session information.

In another example of an implementation of the present technique where websites are being implemented using obscured or obfuscated uniform resource locators (URLs), all URLs are already digested when they arrive at a webserver. The use of obfuscated URLs avoids personal or sensitive data being given away as the obfuscated URL will not, for example, provide any indication of the type, make, model, function or location of the device or information about the owner of the device, which a regular or real URL may provide. The webserver uses the above described technique to rapidly locate the real URL. This allows real URLs to be maintained next to the obfuscated URLs, but it provides a very fast way to determine what the real URL is for any given obfuscated URL. Experimental results comparing various technologies for accessing table data will now be shown. A data set was created containing 100,000,000 text Type 1 UUIDs (Universally Unique Identifiers|). Each UUID consists of a 12-digit MAC address, a timestamp, a time-sequence number, and some control bits. All the tests were run on Python 2.7.14, using a 13-inch Apple MacBook Pro 2017 with the following specification:
4 Thunderbolt 3 Ports);
16 GB 2133 MHz LPDDR3;
3.5 GHz Intel Core i7.

To create a consistent environment, purge was executed before each test (that is, all cached files were cleared). Then, 10,000 random lookups were performed. Both the execution time and the number of first and further refined estimates (guesses”) were recorded. The test was run repeatedly while the mean lookup time continued to decrease, until the mean lookup time became stable. The minimum is represented in the table below as “Hot” lookup times, and the maximum as the “Cold” lookup times.

Hot lookup is meant to represent a table that lives primarily in RAM. This is more about the performance of the method when CPU-bound. Cold lookup is meant to represent when the table lives primarily on disk. This is more about the performance of the method when it is I/O bound. Obviously, the method in question performs well in both situations, but the contrast is most stark when the task is I/O-bound.

The table column headed “Transformed-key search” shows the results achieved by applying one possible implementation of the present technology using the well-known FNV1a hashing algorithm as the computational transformation. The term “Standard Deviation” has been abbreviated to “Std-dev”.

| Lookup | Binary | Interpolation | | Transformed- |
|---|---|---|---|---|
| Method | Search | Search | SQLite | key Search |
| Cold Lookup | 1.631 ms | 1.327 ms | 2.727 ms | 0.507 ms |
| Time Mean | | | | |
| Cold Lookup | 3.436 ms | 0.899 ms | 5.348 ms | 0.327 ms |
| Time Std-dev | | | | |
| Cold Lookup | 25.67 | 6.465 | N/A | 3.292 |
| Guesses Mean | | | | |
| Cold Lookup | 1.47 | 1.697 | N/A | 0.690 |
| Guesses Std- | | | | |
| dev | | | | |
| Hot Lookup | 0.330 ms | 0.097 ms | 0.394 ms | 0.099 ms |
| Time Mean | | | | |
| Hot Lookup | 0.151 ms | 0.0731 ms | 0.201 ms | 0.046 ms |
| Time Std-dev | | | | |
| Hot Lookup | 25.63 | 6.451 | N/A | 3.294 |
| Guesses Mean | | | | |
| Hot Lookup | 1.52 | 1.72 | N/A | 0.711 |
| Guesses Std- | | | | |
| dev | | | | |
| Table size | 3.1 GB | 3.1 GB | 8.7 GB | 3.1 GB |

As will be appreciated by one skilled in the art, the present technique may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Furthermore, the present technique may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising deploying computer program code operable to, when deployed into a computer infrastructure or network and executed thereon, cause said computer system or network to perform all the operations of the method.

In a further alternative, an embodiment of the present technique may be realized in the form of a data carrier having functional data thereon, said functional data comprising functional computer data structures to, when loaded into a computer system or network and operated upon thereby, enable said computer system to perform all the operations of the method.

It will be clear to one skilled in the art that many improvements and modifications can be made to the foregoing exemplary embodiments without departing from the scope of the present technique.

1. A computer-implemented method for accessing table data, comprising:
receiving a request to retrieve data from a table having constant size keys and constant size data, said request specifying a key associated with data to be retrieved, said table having been sorted according to a sort order of transformed values derived by applying a consistent computational transform to each of said constant size keys;
generating a first estimate of a table row for said specified key by transforming said key specified in said request into a transformed value using said consistent computational transform and applying a root-finding method to determine a table row;
testing a table row key at said table row derived from said first estimate for a match with said specified key; and
responsive to finding a matched table row in said testing, returning a data value from said matched table row for said specified key.

2. The method of claim 1, further comprising testing at least one preceding table row key and said at least one succeeding table row key for a match with said specified key, and responsive to finding a matched table row in said testing, returning a data value from said matched table row for said specified key.

3. The method of claim 1, further comprising, responsive to not finding a matched table row in said testing, iteratively applying said root-finding method to refine said first estimate.

4. The method of claim 3, said iteratively applying said root-finding method being combined with a maximum and minimum bound check.

5. The method of claim 4, responsive to said iteratively applying said root-finding method combined with said maximum and minimum bound check producing a result falling outside a range between said maximum and minimum bound, applying an alternative root-finding method to counter divergence.

6. The method of claim 5 said applying an alternative root-finding method comprising applying a bisection method.

7. The method of claim 4, maximum and minimum bounds for said maximum and minimum bound check being established and stored during said iteratively applying said root-finding method.

8. The method of claim 1, said consistent computational transform comprising a hash function.

9. The method of claim 1, further comprising, prior to said performing an estimate of a table row for said specified key, determining that said table row is an element of a subset located in a bucket of a hash table, and limiting said generating said first estimate to said subset.

10. A computer-implemented method for accessing table data, comprising:
receiving a request to retrieve data from a derived table generated from a table having constant size keys and constant size data, said request specifying a key associated with data to be retrieved, said derived table having been sorted according to a sort order of transformed values derived by applying a consistent computational transform to each of said constant size keys, and replacing each said key with its respective transformed value as a table row index value after said derived table has been sorted;
generating a first estimate of a table row for said specified key by transforming said key specified in said request into a respective transformed value using said consistent computational transform and applying a root-finding method to determine a table row;
testing a table row index value at said table row derived from said first estimate for a match with said respective transformed value of said specified key; and
responsive to finding a matched table row in said testing, returning a data value from said matched table row for said specified key.

11. The method of claim 10, further comprising testing at least one preceding table row index value and said at least one succeeding table row index value for a match with said respective transformed value of said specified key, and responsive to finding a matched table row in said testing, returning a data value from said matched table row for said specified key.

12. The method of claim 10, further comprising, responsive to not finding a matched table row in said testing, iteratively applying said root-finding method to refine said first estimate.

13. The method of claim 12, said iteratively applying said root-finding method being combined with a maximum and minimum bound check.

14. The method of claim 13, responsive to said iteratively applying said root-finding method combined with said maximum and minimum bound check producing a result falling outside a range between said maximum and minimum bound, applying an alternative root-finding method to counter divergence.

15. The method of claim 14, said applying an alternative root-finding method comprising applying a bisection method.

16. The method of claim 13, maximum and minimum bounds for said maximum and minimum bound check being established and stored during said iteratively applying said root-finding method.

17. The method of claim 10, said consistent computational transform comprising a hash function.

18. The method of claim 10, further comprising, prior to said performing an estimate of a table row for said specified key, determining that said table row is an element of a subset located in a slot of a hash table, and limiting said generating said first estimate to said subset.

19. A computer-implemented method for sorting a table, comprising:
applying a consistent computational transform to constant size keys of a table to generate transformed values, the table comprising the constant size keys and associated constant size data; and
sorting the keys and data of the table according to a sort order of transformed values.

20. The method of claim 19, further comprising discarding the transformed values, or, retaining the transformed values and discarding the keys.
